(19) United States
(12) Patent Application Publication
(10) Pub. No.: US 2012/0238671 A1
(43) Pub. Date: Sep. 20, 2012

(54) SILICONE RESIN EMULSION AND USE THEREOF IN HYDROPHOBING PLASTER

(75) Inventors: Sabine Hoffmann, Radebeul (DE); Michael Messner, Semmelsberg (DE); Daniel Schildbach, Altoetting (DE)

(73) Assignee: WACKER CHEMIE AG, Munich (DE)

(21) Appl. No.: 13/514,027

(22) PCT Filed: Nov. 26, 2010
(86) PCT No.: PCT/EP10/68310

§ 371 Date: Jun. 5, 2012

(30) Foreign Application Priority Data
Dec. 7, 2009 (DE) 10 2009 047 582.6

(51) Int. Cl. C04B 26/10; C08L 83/04

(52) U.S. Cl. 524/3; 524/837

(57) ABSTRACT

Silicone resin emulsions especially suitable for hydrophobing gypsum compositions together with H-siloxanes are prepared by hydrolysis and subsequent distillation to an alcohol content of less than 0.1 weight percent. Use of the emulsion with H-siloxanes provides plaster products such as plasterboard of increased hydrophobicity.

### CROSS-REFERENCE TO RELATED APPLICATION

This application is the U.S. national phase of PCT Appln. No. PCT/EP2010/068310 filed Nov. 26, 2010 which claims priority to German application DE 10 2009 047 582.6 filed Dec. 7, 2009 which are incorporated herein by reference.

### BACKGROUND OF THE INVENTION

1. Field of the Invention

The invention relates to silicone resin emulsions and a process for hydrophobing gypsum wherein gypsum is treated with H-siloxane and the silicone resin emulsions.

2. Description of the Related Art

Siloxanes containing two or more hydrogen atoms directly attached to silicon (H-siloxanes) and especially polymethylhydrogensiloxanes are outstandingly suitable for gypsum hydrophobing. It is the most effective agent of all, i.e., very good hydrophobicity is achieved by adding very small amounts, usually in the range of 0.2-0.6 wt %. Since the amount of this H-containing product is limited by the silanes available from the Müller-Rochow process required for their synthesis, alternatives are sought.

Gypsum hydrophobing is a special case in building product chemistry. Gypsum hydrophobing is described extensively in Linda Jakobsmeier's thesis (Munich Technical University, 2000). The effect of polymethylhydrogensiloxane and trimethoxymethylsilane is reported at length. Trimethoxymethylsiloxane is disadvantageous because of the formation of methanol.

DE 10220659 A describes improving the water-repellent effect of H-siloxane by adding starch ethers.

The water-repellent effect of H-siloxanes can be improved by addition of alkaline compounds. This often gives rise to incompatibility with other gypsumboard constituents. The detachment of hydrogen in the alkaline region necessitates increased safety requirements.

Aqueous emulsions of polymethylhydrogensiloxane are also in use for gypsum hydrophobing. EP 1083157 A describes an emulsion consisting of organohydrogensiloxane, polyvinyl alcohol, water and an amino-functional compound such as an aminosilanes or an organic amine.

US 2007022913 A describes a gypsum slurry consisting of gypsum, fly ash as an extremely inexpensive catalyst, magnesium oxide and an emulsion of water and solventless methylhydrogensiloxane.

DE 19517346 A describes emulsions of organosilicon compounds, particularly alkoxy-containing organsiloxane compounds. The poor storage stability and declining hydrophobing effect of emulsions of alkoxysilanes are pointed out there. The use of methoxysilanes is also counseled against in DE 19707219 and DE 19904496 for example.

U.S. Pat. No. 5,776,245 for example states that the presence of emulsifiers is adverse for the hydrophobing effect.

### SUMMARY OF THE INVENTION

An object addressed by the present invention was that of providing an alternative to organohydrogen-polysiloxane for gypsum hyodrophobing. These and other objects are achieved by providing silicone resin emulsions (SE) obtainable by a process wherein a first step comprises mixing 100 parts by weight of alkyltrialkoxysilane of the general formula I

R(R¹O)₃Si (I),

with 0 to 5 parts by weight of alkylalkoxysilane of the general formula II

R′ₐ(R^{1′}O)_{b}Si (II),

with 400 to 2500 parts by weight of water and 5 to 50 parts by weight of emulsifier at 10 to 100° C. to form alcohol R¹OH with or without R^{1″}OH and a second step comprises distilling the first step product alcohol R¹OH and, if present, R^{1′}OH off down to a total alcohol content of not more than 0.5 wt %, wherein

R and R′ are alkyl moieties of 1-10 carbon atoms,

R¹ and R^{1′} are alkyl moieties of 1-6 carbon atoms,

a is 0, 1, 2 or 3, and

b is 1, 2, 3 or 4.

### DETAILED DESCRIPTION OF THE PREFERRED EMBODIMENTS

The invention also provides a process for hydrophobing gypsum, which comprises treating gypsum with H-siloxane comprising units of the general formulae III, IV, V, VI, and VII

R³₃SiO_{1/2} (III),

R³HSiO_{2/2} (IV),

R³₂SiO_{2/2} (V),

R³SiO_{3/2} (VI),

SiO_{4/2} (VII),
where

R³ represents alkyl moieties of 1-10 carbon atoms, and with the silicone resin emulsion (SE) as described above.

In hydrophobing gypsum, the silicone resin emulsion (SE) not only replaces some H-siloxane, but an appreciably smaller amount of silicone resin (S) suffices in the silicone resin emulsion (SE) to achieve an equivalent or superior hydrophobing of gypsum than is achieved with H-siloxane alone. There is a synergistic effect.

The silicone resin emulsion (SE) retains its gypsum-hydrophobing ability over months of storage time, unlike concentrated emulsions or purely hydrolyzates of methyltrimethoxysilane. It is surprising that the silicone resin emulsions (SE) stored for months combine with H-siloxane to produce outstanding effects in gypsum hydrophobing. The gypsum hydrophilicity due to the emulsifier content is strongly supercompensated by the hydrophobing effect of the emulsified silicone resin.

The use of silicone resin emulsion (SE) for hydrophobing gypsum is environmentally unconcerning because the residual amounts of alcohol are small.

The alkyl moieties R and R′ each preferably have from 1 to 6 carbon atoms and ethyl and methyl are are particularly preferred.

The alkyl moieties R¹ and R^{1′} each preferably have from to 3 carbon atoms and ethyl and methyl are are particularly preferred.

The process preferably utilizes not more than 2 parts by weight of alkylalkoxysilane of the general formula II, the process more preferably utilizes not more than 0.5 part by weight of alkylalkoxysilane of the general formula II and the process most preferably utilizes no alkylalkoxysilane of the general formula II.

The amount of water used in the process is preferably not less than 500 and more preferably not less than 600, and not more than 2000 and more preferably not more than 900 parts by weight.

The amount of emulsifier used in the process is preferably not less than 10 and more preferably not less than 15 and not more than 50 and more preferably not more than 30 parts by weight.

The temperature at which the process is carried out is preferably not less than 15° C. and not more than 95° C. and more preferably not more than 50° C. The higher the water content set in the process, the higher the temperature is permitted to be.

The mixing step is preferably performed for not less than 10 minutes and more preferably performed for not less than 30 minutes. The reaction time is at least 30 min and not more than 2 hours at temperatures up to 50° C. At higher temperatures, the reaction time shortens in a corresponding manner.

The level of emulsified silicone resin (S) formed at the end of the first step is preferably not less than 2 wt %, more preferably not less than 4 wt % and especially not less than 5 wt % and not more than 10 wt % and preferably not more than 8 wt % of the emulsion.

The distillation in the second step is preferably carried on to a total alcohol content of not more than 0.1 wt %, more preferably not more than 0.01 wt % and most preferably not more than 0.001 wt %.

The distillation serves to reduce the water content as well as remove alcohol. The concentration desired for the emulsion can be set and excess water used afresh for emulsion production.

Particularly good storage stability is achieved for the silicone resin emulsion (SE) when the distilling step is subdivided into two or more stages. The first stage is preferably carried out at a temperature of not less than 93° C., most preferably not less than 95° C. and preferably not more than 105° C., more preferably not more than 102° C. and most preferably not more than 100° C. The pressure is chosen such that the desired temperature becomes established. The pressure is preferably in the range from 900 to 1100 mbar.

The second stage is preferably carried out at a temperature of not less than 20° C., more preferably not less than 30° C. and most preferably not less than 40° C. and preferably not more than 70° C., more preferably not more than 60° C. and most preferably not more than 50° C. The pressure is chosen such that the desired temperature becomes established. The pressure is preferably in the range from 1 to 100 mbar.

When there are still further distillation stages, it is preferable to select the process conditions of the preferred ranges of the second stage.

The distillation in two or more stages provides a storage stability to the silicone resin emulsion (SE) amounting to at least one year.

The distillation, especially in the first distillation stage, is capable of recovering most of the alcohol R¹OH and, if present, R^{1′}OH.

Any emulsifier suitable for producing silicone emulsions can be used.

Suitable anionic emulsifiers are particularly:

1. Alkyl sulfates, particularly those having a chain length of 8 to 18 carbon atoms, alkyl and alkaryl ether sulfates having 8 to 18 carbon atoms in the hydrophobic moiety and 1 to 40 ethylene oxide (EO) and/or propylene oxide (PO) units.

2. Sulfonates, particularly alkyl sulfonates having 8 to 18 carbon atoms, alkylaryl sulfonates having 8 to 18 carbon atoms, taurides, esters and monoesters of sulfo-succinic acid with monohydric alcohols or alkylphenols having 4 to 15 carbon atoms; these alcohols or alkyl-phenols may optionally also be ethoxylated with from 1 to 40 EO units.

3. Alkali metal and ammonium salts of carboxylic acids having 8 to 20 carbon atoms in the alkyl, aryl, alkaryl or aralkyl moiety.

4. Phosphoric partial esters and their alkali metal and ammonium salts, particularly alkyl and alkaryl phosphates having 8 to 20 carbon atoms in the organic moiety, alkyl ether or alkaryl ether phosphates having 8 to 20 carbon atoms in the alkyl or, respectively, alkaryl moiety and 1 to 40 EO units.

Suitable nonionic emulsifiers are particularly:

5. Polyvinyl alcohol, preferably polyvinyl alcohol which still contains 5 to 50%, especially 8 to 20% of vinyl acetate units, with a preferred degree of polymerization in the range from 500 to 3000.

6. Alkyl polyglycol ethers, preferably those with 8 to 40 EO units and alkyl of 8 to 20 carbon atoms.

7. Alkylaryl polyglycol ethers, preferably those with 8 to 40 EO units and 8 to 20 carbon atoms in the alkyl and aryl moieties.

8. Ethylene oxide-propylene oxide (EO-PO) block copolymers, preferably those having 8 to 40 EO and/or PO units.

9. Addition products of alkylamines with alkyl of 8 to 22 carbon atoms with ethylene oxide or propylene oxide.

10. Fatty acids of 6 to 24 carbon atoms.

11. Alkylpolyglycosides of the general formula R*—O-Zo, where R* is a linear or branched, saturated or unsaturated alkyl having on average 8-24 carbon atoms and Zo is an oligoglycoside moiety having on average o=1-10 hexose or pentose units or mixtures thereof.

12. Natural products and derivatives thereof, such as lecithin, lanolin, saponins, cellulose; cellulose alkyl ethers and carboxyalkylcelluloses, the alkyl groups of which each have up to 4 carbon atoms.

13. Linear organo(poly)siloxanes containing polar groups, especially those linear organo(poly)siloxanes containing alkoxy groups having up to 24 carbon atoms and/or up to 40 EO and/or PO groups.

Suitable cationic emulsifiers are particularly:

14. Salts of primary, secondary and tertiary fatty amines of 8 to 24 carbon atoms with acetic acid, sulfuric acid, hydrochloric acid and phosphoric acids.

15. Quaternary alkyl- and alkylbenzeneammonium salts, especially those where the alkyl group has from 6 to 24 carbon atoms, especially the halides, sulfates, phosphates and acetates.

16. Alkylpyridinium, alkylimidazolinium and alkyl-oxazolinium salts, especially those where the alkyl chain has up to 18 carbon atoms, specifically the halides, sulfates, phosphates and acetates.

Suitable ampholytic emulsifiers are particularly:

17. Amino acids having long-chain substituents, such as N-alkyldi(aminoethyl)glycine or N-alkyl-2-amino-propionic acid salts.

18. Betaines, such as N-(3-acylamidopropyl)-N,N-di-methylammonium salts with C₈-C₁₈ acyl and alkyl-imidazolium betaines.

Nonionic emulsifiers are particularly preferred, especially polyvinyl alcohol.

The H-siloxane useful in hydrophobing of gypsum preferably has the general formula VIII

R³₃SiO(R³HSiO)ₓ(R³₂SiO)_{y}SiR³₃ (VIII)

where R³ is as defined above,

x is an integer from 10 to 200, and

y is an integer from 0 to 100.

It is preferable for x to be not less than 20, more preferably not less than 30 and most preferably not less than 40 and preferably not more than 150, more preferably not more than 100 and most preferably not more than 70.

It is preferable for y to be not more than 50, more preferably not more than 20 and most preferably not more than 5. In one particularly preferred version, y is 0.

Among the types of gypsum it is plaster (CaSO₄.0.5 H₂O) which is preferred, for example in the form of calcined gypsum, stucco gypsum, modeling gypsum or insulating gypsum. Other types of gypsum, such as flooring gypsum, Keene's cement, anhydrite and flue gas desulfurization calcium sulfate are also highly suitable. The gypsum may contain additives to facilitate the production of sharped gypsum articles or improve the properties of sharped gypsum articles. Additives include, for example, fillers such as silicon dioxide and cellulose fibers; accelerators such as potassium sulfate and aluminum sulfate; retarders such as proteins or tartaric acid salts; plasticizing agents for the gypsum mass such as ligninsulfonates and adhesion promoters for cardboard such as starch.

It is preferable for the treatment of gypsum to use, per 100 parts by weight of H-siloxane of the general formula III, an amount of silicone resin emulsion (SE) that contains not less than 5, more preferably not less than 10 and most preferably not less than 15 parts by weight and not more than 60, more preferably not more than 50 and most preferably not more than 30 parts by weight of emulsified silicone resin (S) as an active ingredient. The above active-ingredient contents also provide a particularly storage-stable silicone resin emulsion (SE).

It is preferable for the treatment of gypsum to use, per 100 parts by weight of gypsum, not less than 0.05 and more preferably not less than 0.1 part by weight and not more than 1 and more preferably not more than 0.5 part by weight of H-siloxane.

It is preferable for the treatment of gypsum to utilize H-siloxane in solventless form, but it can also be diluted with a solvent.

It is preferable for H-siloxane and silicone resin emulsion (SE) to be stored separately from each other. They are preferably added to the gypsum in succession or mixed immediately before the hydrophobing.

Gypsum hydrophobing is preferably practiced as bulk hydrophobing. When gypsum, H-siloxane and silicone resin emulsion (SE) are combined for this purpose into a shapeable composition, water has to be added. It is preferable for 30 to 140 and especially 50 to 100 parts by weight of water to be added per 100 parts by weight of gypsum.

In one preferred embodiment, a gypsum mass is prepared containing gypsum, water, H-siloxane and silicone resin emulsion (SE). This gypsum mass may also be expanded into a gypsum foam by incorporation of air.

The gypsum mass can be shaped to produce shaped gypsum articles. Shaped gypsum articles can also be given the hydrophobing treatment with H-siloxane and silicone resin emulsion (SE) after shaping, after setting or even after drying the treatment may take the form for example of dipping, spraying or brushing with the silicone resin emulsion (SE) and H-siloxane.

Examples of shaped gypsum articles are gypsumboard panels, such as wallboard panels or gypsum-paper plasterboard panels.

The above symbols in the above formulae all each have their meanings independently of one another. The silicon atom is tetravalent in all formulae.

In the examples hereinbelow, quantities and percentages are all by weight, all pressures are 0.10 MPa (abs.) and all temperatures are 20° C., unless otherwise stated in each case.

Preparing an Aqueous, Solventless Methyl Resin Emulsion (SE)

A 1.5 1 reaction flask fitted with stirrer and distillation head is initially charged with 600 g of water and 90 g of 20% polyvinyl alcohol solution under agitation. 102 g of methyltrimethoxysilane are metered into the liquid over 30 min and subsequently stirred at room temperature for a further two hours. The active-ingredient concentration after hydrolysis has ended is 6.3 wt %.

This is followed by the start of the 2-stage distillation. The first stage is carried out at 93 to 99° C. and the second stage at 45° C. and 50 mbar.

In accordance with the distillate quantity over both stages, the resulting concentrations of active ingredient (methyl resin) and emulsifier (polyvinyl alcohol) are as follows:

200 g of distillate =>8.5% of methyl resin, 3% of emulsifier 400 g of distillate =>12.8% of methyl resin, 4.6% of emulsifier

500 g of distillate =>17.2% of methyl resin, 6.2% of emulsifier

The emulsions are storage stable for more than a year and do not change their gypsum-hydrophobing properties.

Use of Methyl Resin Emulsion (SE) in Gypsum Hydrophobing

Gypsum specimen articles are produced as follows: 80 parts by weight of partially ion-free water, H-siloxane mixture of the formula

(CH₃)₃SiO((CH₃)HSiO)ₓSi(CH₃)₃x48-55

and methyl resin emulsion are stirrer mixed at 1000 rpm for 120 s. Thereafter, 100 parts by weight of modeling gypsum are added and stirring is continued for a further 120 s.

The resulting gypsum mass is poured into PVC molds to form specimen disks 8 cm in diameter and 2 cm in height. After 1 hour storage at 20° C. the solidified specimens are demolded. The specimens are first dried upright at 40° C. for 24 hours and then stored at 20° C. for 3 days.

Water imbibition is then determined to DIN 18180. The specimens are immersed horizontally in water at 23° C. such that there is a 2 cm column of water above the specimen surface. After two hours of immersion in water, the specimens are removed from the water, the water adhering to the surface is removed and the weight increase is determined by weighing.

Since the gypsum-hydrophobing effect is very substantially dependent on gypsum quality, a determination with purely H-siloxane is also carried out as part of every series of tests. The values reported in the tables are always the result of duplicate determinations.

The examples report the amount of H-siloxane and methyl resin emulsion that is used per 100 parts by weight of modeling gypsum.

### EXAMPLE 1

### Test Series with Gypsum Batch A (Modeling Gypsum)

Test T1, which is comparative, i.e., not in accordance with the present invention, involves adding 0.4 part by weight of H-siloxane.

Tests T2-T8, which are in accordance with the present invention, involve adding 0.2 part by weight of H-siloxane and 0.2 part by weight of methyl resin emulsion.

Table 1 reports the levels of methyl resin, emulsifier and total solids in the methyl resin emulsions and also the DIN 18180 water imbibition for the T1-T8 tests.

TABLE 1

| | Methyl resin | | Total | Water |
|---|---|---|---|---|
| | content of | Emulsifier | solids | imbibition |
| Test | emulsion (%) | (%) | (%) | (%) |
| T1 H-siloxane* | — | — | — | 13.2 |
| T2 | 11.1 | 16.6 | 27.7 | 4.7 |
| T3 | 18.8 | 13.4 | 32.2 | 6.8 |
| T4 | 9.3 | 6.6 | 15.9 | 7.2 |
| T5 | 16.7 | 6.7 | 23.4 | 6.0 |
| T6 | 15.4 | 5.5 | 20.9 | 5.8 |
| T7 | 16.4 | 5.9 | 22.3 | 4.8 |
| T8 | 16.6 | 5.9 | 22.5 | 5.1 |

*not in accordance with the present invention

### EXAMPLE 2

### Test Series with Gypsum Batch B (Modeling Gypsum)

Test T9, which is comparative, i.e., not in accordance with the present invention, involves adding 0.4 part by weight of H-siloxane.

Tests T10i-T12i, which are in accordance with the present invention, involve adding 0.2 part by weight of H-siloxane and 0.2 part by weight of methyl resin emulsion. The methyl resin emulsions each contain 0.5% of acetic acid.

Table 2 reports the levels of methyl resin, emulsifier and total solids in the methyl resin emulsions and also the DIN 18180 water imbibition for the T9 and T10i-T12i tests.

TABLE 2

| | Methyl resin | | Total | Water |
|---|---|---|---|---|
| | content of | Emulsifier | solids | imbibition |
| Test | emulsion (%) | (%) | (%) | (%) |
| T9 H-siloxane* | — | — | — | 16.9 |
| T10i | 31.7 | 12.8 | 44.5 | 7.4 |
| T11i | 31.6 | 12.7 | 44.3 | 6.8 |
| T12i | 33.9 | 13.7 | 47.6 | 3.3 |

*not in accordance with the present invention

### EXAMPLE 3

### Test Series with Gypsum Batch C (Modeling Gypsum)

Test T13, which is comparative, i.e., not in accordance with the present invention, involves adding 0.4 part by weight of H-siloxane.

Tests T14-T22, which are in accordance with the present invention, involve adding 0.2 part by weight of H-siloxane and the parts by weight of methyl resin emulsion which are reported in Table 3.

Table 3 reports the levels of methyl resin, emulsifier and total solids in the methyl resin emulsions and also the DIN 18180 water imbibition for the T13 to T22 tests.

TABLE 3

| Test and amount | Methyl resin | | Total | Water |
|---|---|---|---|---|
| of methyl resin | content of | Emulsifier | solids | imbibition |
| emulsion | emulsion (%) | (%) | (%) | (%) |
| T13 H-siloxane* | — | — | — | 19.4 |
| T14 0.2 | 11 | 5.9 | 16.9 | 13.1 |
| T15 0.2 | 28.4 | 15.2 | 43.6 | 17.9 |
| T16 0.1 | 28.4 | 15.2 | 43.6 | 14.1 |
| T17 0.2 | 13.2 | 7.1 | 20.3 | 15.6 |
| T18 0.2 | 27.3 | 14.7 | 42 | 17.2 |
| T19 0.1 | 27.3 | 14.7 | 42 | 11.8 |
| T20 0.2 | 12.2 | 6.6 | 18.8 | 12.9 |
| T21 0.2 | 23.2 | 12.5 | 35.7 | 11.1 |
| T22 0.1 | 23.2 | 12.5 | 35.7 | 8 |

*not in accordance with the present invention

All the tests in accordance with the present invention show a dramatic saving in H-siloxane coupled with improved hydrophobing.

The higher the concentration of the emulsion is, the less the amount that needs to be used for gypsum hydrophobing. However, higher concentrations are associated with a distinct increase in viscosity and there is a risk that larger molecules will cause a reduction in or loss of gypsum-hydrophobing efficacy. The emulsions are then already cream-like, which is disadvantageous for metering.

1.-8. (canceled)

9. A silicone resin emulsion (SE) prepared by a process comprising,
a) in a first step, mixing 100 parts by weight of alkyltrialkoxysilane of the formula I
R(R¹O)₃Si (I),
0 to 5 parts by weight of alkylalkoxysilane of the formula II
R′ₐ(R^{1′}O)_{b}Si (II),
400 to 2500 parts by weight of water, and
5 to 50 parts by weight of emulsifier, at 10 to 100° C. to form alcohol R¹OH with or without R^{1′}OH, and
b) in a second step, distilling of the first step product alcohol R¹OH and, if present, R^{1′}OH down to a total alcohol content of not more than 0.1 wt %, wherein
R and R′ are alkyl moieties of 1-10 carbon atoms,
R¹ and R^{1′} are alkyl moieties of 1-6 carbon atoms,
a is 0, 1, 2 or 3, and
b is 1, 2, 3 or 4.

10. The silicone resin emulsion (SE) of claim 9, wherein the alkyl moieties R, R′, R¹ and R^{1′} are methyl radicals.

11. The silicone resin emulsion (SE) of claim 9, wherein the distilling step in the synthesis is subdivided into two or more stages and the first stage is carried out at a temperature of not less than 93° C.

12. The silicone resin emulsion (SE) of claim 10, wherein the distilling step in the synthesis is subdivided into two or more stages and the first stage is carried out at a temperature of not less than 93° C.

13. A process for hydrophobing gypsum, comprising treating gypsum with at least one H-siloxane comprising units of the formulae III, IV, V, VI, and or VII
R³₃SiO_{1/2} (III),
R³HSiO_{2/2} (IV),
R³₂SiO_{2/2} (V),
R³SiO_{3/2} (VI),
SiO_{4/2} (VII),
wherein
R³ are alkyl moieties of 1-10 carbon atoms, and a silicone resin emulsion (SE) of claim 9.

14. The process of claim 13, wherein the amount of silicone resin emulsion (SE) used per 100 parts by weight of H-siloxane of the general formula III contains from 5 to 60 parts by weight of emulsified silicone resin (S) as an active ingredient.

15. The process of claim 13, wherein 0.05 to 0.5 part by weight of H-siloxane is used per 100 parts by weight of gypsum.

16. The process of claim 14, wherein 0.05 to 0.5 part by weight of H-siloxane is used per 100 parts by weight of gypsum.

17. The process of claim 13, wherein said hydrophobing of gypsum comprises bulk hydrophobing.

18. The process of claim 17, wherein a gypsum mass is prepared containing gypsum, water, H-siloxane and silicone resin emulsion (SE) of claim 9.
